(19) United States
(12) Patent Application Publication
(10) Pub. No.: US 2021/0390522 A1
(43) Pub. Date: Dec. 16, 2021

(54) APPARATUSES AND METHODS FOR GENERATING USER CONNECTIONS

(71) Applicant: Wells Fargo Bank, N.A., San Francisco, CA (US)

(72) Inventors: Amanda Jean ANDRES, Smithton, IL (US); John Patrick DECKER, Jr., Saint Louis, MO (US); Darrell Todd SLAWSON, St. Louis, MO (US); Jonathan Paul SIDAROUS, House Springs, MO (US); Melissa LEISSE, Fenton, MO (US); Chelsea MURPHY, Saint Louis, MO (US); Allison RAYFIELD, St. Louis, MO (US)

(21) Appl. No.: 16/900,250

(22) Filed: Jun. 12, 2020

(51) Int. Cl. G06Q 20/10; G06Q 40/02; G06Q 20/42; G06Q 20/40; G06Q 30/00

(52) U.S. Cl. CPC G06Q 20/108; G06Q 40/02; G06Q 30/0185; G06Q 20/40; G06Q 20/42

(57) ABSTRACT

Apparatuses, methods, and computer program products are provided for generating user connections. An example method includes receiving first user account parameters associated with a first user and determining a financial deficiency of the first user account based on the first user account parameters. The method further includes receiving second user account parameters associated with a second user and determining a fulfillment opportunity of the second user account based on the second user account parameters. In response to the determined fulfillment opportunity, the method includes generating a fulfillment action from a second account of the second user to a first account of the first user in satisfaction of the financial deficiency.

### TECHNOLOGICAL FIELD

Example embodiments of the present disclosure relate generally to financial systems and, more particularly, to generating user connections.

### BACKGROUND

Financial institutions often have access to a large amount of user data, user account data, and the like generated in the course of user interactions with these institutions. This data may be utilized by these entities to suggest financial products and/or financial transactions to their customers. Financial institutions may also leverage this user data in an attempt to connect their customers.

### BRIEF SUMMARY

As described above, financial institutions have traditionally had access to a large amount of user data from user accounts, transactions, mortgage information, and the like, generated by user interactions with these institutions. Many users, customers, account holders, and the like of the financial institution may also be successful financially such that there exists a need to reward these High Net Worth (HNW) individuals without monetary rewards. By way of example, HNW customers may desire to contribute to charitable causes, new businesses, low net worth individuals, etc. but are unsure how to proceed. In many instances, the volume of potential charities is so large that HNW individuals may struggle to identify reputable organizations for donation. Furthermore, many HNW individuals prefer to remain anonymous or private with regard to their donations; a difficult feat when these HNW individuals are unfamiliar with the charitable organization. In this way, traditional mechanisms for charitable giving or connecting with HNW individuals may be uncertain and burdensome to HNW individuals often resulting in reduced overall giving or donations.

To solve these issues and others, the embodiments described herein generate connections between users in the context of the reliable and secure network of a financial institution. For example, although some individuals may not work with a financial advisor, these individuals may still connect with a financial intuition in other ways (e.g., account opening, mortgages, lines of credit, etc.). As such, the embodiments described herein are uniquely positioned to identify potential opportunities for HNW individuals by monitoring small business loans, grant applications, lines of credit fluctuations, and the like. In doing so, the system may provide a secure system internal to the financial institution for access by the HNW individual so as to reduce any potential fraud. Said differently, the financial institution's access to user account data may ensure that potential donation opportunities are legitimate. By using a system that is internal to the financial institution, HNW individuals may also receive anonymity, if desired, and may enjoy increased ease of use in that funds may be instantly transferred. Furthermore, the systems and methods described herein do not require action on the part of the recipient of any financial transfer of funds (e.g., the system identifies recipients as described hereafter).

To solve these issues and others, example implementations of embodiments of the present disclosure may determine a financial deficiency of a first user based on one or more account parameters (e.g., liquidity concerns, application denials, etc.). The embodiments of the present application may further receive account parameters of a second user (e.g., HNW individual) and determine a fulfillment opportunity based on the account parameters of this second user. In response to the fulfillment opportunity, the described systems may generate a fulfillment action from an account of the second user to an account of the first user in satisfaction of the financial deficiency. In this way, the inventors have identified that the advent of emerging computing technologies have created a new opportunity for solutions for generating user connections which were historically unavailable. In doing so, such example implementations confront and solve at least three technical challenges: (1) they automatically determine financial deficiencies associated with users, (2) they dynamically identify user fulfillment opportunities, and (3) they streamline financial transactions between selected users.

As such, apparatuses, methods, and computer program products are provided for generating user connections. With reference to an example method, the example method may include receiving, via a computing device, first user account parameters associated with a first user. The method may include determining, via identification circuitry of the computing device, a financial deficiency of the first user based on the first user account parameters. The method may further include receiving, via the computing device, second user account parameters associated with a second user and determining, via funding circuitry of the computing device, a fulfillment opportunity of the second user based on the second user account parameters. In response to the fulfillment opportunity, the method may include generating, via the funding circuitry of the computing device, a fulfillment action from a second account of the second user to a first account of the first user in satisfaction of the financial deficiency.

In some embodiments, determining the fulfillment opportunity may further include transmitting, via the computing device, an approval request to a second user device of the second user. In such an embodiment, the method may further include, generating, via the funding circuitry, the fulfillment action in an instance in which the computing device receives an approval notification from the second user device.

In some embodiments, determining the financial deficiency further includes determining, via the identification circuitry, if at least one of the first user account parameters satisfies a liquidity threshold. In an instance in which at least one of the first user account parameters satisfies a liquidity threshold, the method may further include determining, via the identification circuitry, the financial deficiency.

In other embodiments, determining the financial deficiency further includes determining, via the identification circuitry, if the first user account parameters include one or more application denial data entries. In an instance in which the first user account parameters include at least one application denial data entry, the method may include determining, via the identification circuitry, the financial deficiency.

In some embodiments, the fulfillment action may also include one or more funding obligations. In such an embodiment, the method may also include monitoring, via the funding circuitry, compliance of the first user account with respect to the one or more funding operations.

In some further embodiments, the method may include transmitting, via the computing device, a noncompliance notification to a second user device in an instance in which the first user account fails to comply with the one or more funding obligations.

In other embodiments, the method may include rescinding, via the funding circuitry, the fulfillment action in an instance in which the first user account fails to comply with the one or more funding obligations.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for generating user connections, in accordance with some example embodiments described herein.

FIG. 4 illustrates an example flowchart for financial deficiency determinations, in accordance with some example embodiments described herein.

FIG. 5 illustrates an example flowchart for funding obligation monitoring, in accordance with some example embodiments described herein.

### DETAILED DESCRIPTION

Some embodiments of the present disclosure will now be described more fully hereinafter with reference to the accompanying drawings, in which some, but not all embodiments are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a user connection server as an example “apparatus.” However, elements of the apparatus described herein may be equally applicable to the claimed method and computer program product. Thus, use of any such terms should not be taken to limit the spirit and scope of embodiments of the present disclosure.

### Definition of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used herein to mean “serving as an example, instance, or illustration.” Any implementation described herein as “example” is not necessarily to be construed as preferred or advantageous over other implementations.

As used herein, the terms “user device,” “first user device,” “second user device,” and the like refer to computer hardware and/or software that is configured to access a service made available by the user connection server and, among various other functions, is configured to directly, or indirectly, transmit and receive at least user account data. Example user devices may include a smartphone, a tablet computer, a laptop computer, a wearable device (e.g., smart glasses, smartwatch, or the like), and the like. In some embodiments, a user device may include a “smart device” that is equipped with chip of other electronic device that is configured to communicate with the user connection server via Bluetooth, NFC, Wi-Fi, 3G, 4G, 5G, RFID protocols, and the like. By way of a particular example, a first user device may be a first mobile device associated with a first user, and a second user device may a second mobile device associated with a second user, where each user device is equipped with a Wi-Fi radio that is configured to communicate with a Wi-Fi access point that is in communication with the a server (e.g., a user connection server of the present disclosure) via a network.

As used herein, the term “first user account” refers to a collection of settings, configurations, identifiers, data, and information associated with a first user and first user device. A first user account configured in accordance with the present disclosure may be accessible by one or more of the software applications that are supported by the user connection server and, thus, may include application-specific preferences, settings, configurations, data, and information. In some example embodiments, a first user account may include first user account information, preferences, transaction information, and/or the like associated with the first user as described hereafter. Furthermore, the first user account may include first user account parameters that correspond to various information and operations (e.g., account balance, lines of credit, loan applications, wire transfers, or the like) of the first user account.

As used herein, the term “second user account” refers to a collection of settings, configurations, identifiers, data, and information associated with a second user and second user device. A second user account configured in accordance with the present disclosure may be accessible by one or more of the software applications that are supported by the user connection server and, thus, may include application-specific preferences, settings, configurations, data, and information. In some example embodiments, a second user account may include second user account information, preferences, transaction information, and/or the like associated with the second user as described hereafter. Furthermore, the second user account may include second user account parameters that correspond to various information and operations (e.g., account balance, lines of credit, loan applications, wire transfers, or the like) of the second user account.

As used herein, the term “deficiency database” refers to a data structure or repository for storing user account parameters associated with determined financial deficiencies as described herein. As described above, these user account parameters may correspond to various information and operations (e.g., account balance, lines of credit, loan applications, wire transfers, or the like) of the respective user account. Furthermore, the deficiency database may store user account data and parameters associated with users that, due to a determined financial deficiency, may receive a fulfillment action as described herein (e.g., a recipient of funds).

As used herein, the term “fulfillment database” refers to a data structure or repository for storing user account parameters associated with determined fulfillment opportunities as described herein. As described above, these user account parameters may correspond to various information and operations (e.g., account balance, lines of credit, loan applications, wire transfers, or the like) of the respective user account. Furthermore, the fulfillment database may store user account data and parameters associated with users that, due to a determined fulfillment opportunities, may transmit a fulfillment action as described herein (e.g., a donor of funds).

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

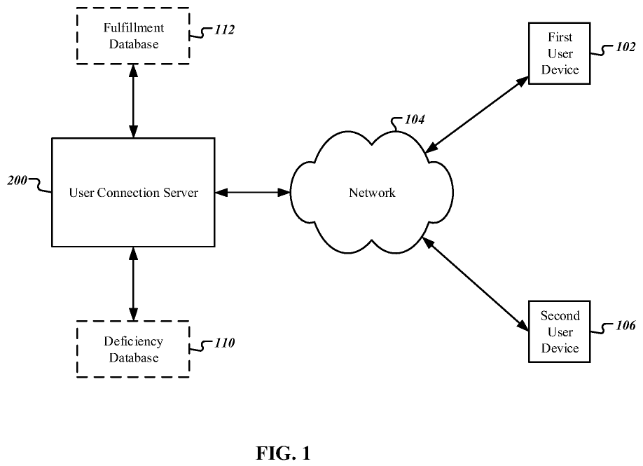

With reference to FIG. 1, an example system 100 is illustrated with an apparatus (e.g., a user connection server 200) communicably connected via a network 104 to a first user device 102, and a second user device 106. The example system 100 may also include a deficiency database 110 and/or a fulfillment database 112 that may be hosted by the user connection server 200 or otherwise hosted by devices in communication with the user connection server 200. Although illustrated connected to the user connection server 200 via a network 104, the present disclosure contemplates that one or more of the first user device 102 and/or the second user device 106 may be hosted and/or stored by the user connection server 200.

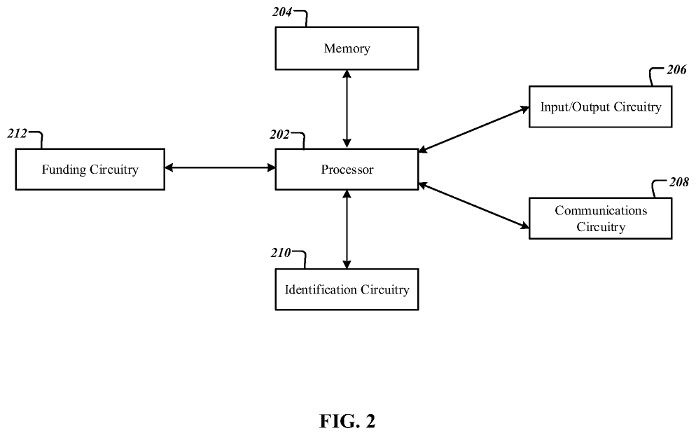

The user connection server 200 may include circuitry, networked processors, or the like configured to perform some or all of the apparatus-based (e.g., user connection server-based) processes described herein, and may be any suitable network server and/or other type of processing device. In this regard, user connection server 200 may be embodied by any of a variety of devices. For example, the user connection server 200 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the user connection server 200 may be located remotely from the first user device 102, the second user device 106, the deficiency database 110, and/or the fulfillment database 112, although in other embodiments, the user connection server 200 may comprise the first user device 102, the second user device 106, the deficiency database 110, and/or the fulfillment database 112. The user connection server 200 may, in some embodiments, comprise several servers or computing devices performing interconnected and/or distributed functions. Despite the many arrangements contemplated herein, the user connection server 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The first user device 102 may be associated with a first user and first user account. Although a single first user device 102 is shown in FIG. 1, the example system 100 may include any number of user devices associated with the first user. The first user device 102 may be a cellular telephone (including smartphones and/or other types of mobile telephones), laptop, tablet, electronic reader, e-book device, media device, wearable, smart glasses, smartwatch, or any combination of the above. The first user device 102 may be communicably coupled with the user connection server 200, via the network 104, and configured to transmit data to and receive data from the user connection server 200. By way of example, the first user device 102 may include a mobile phone configured to access a first user account associated with the first user.

The second user device 106 may be associated with a second user and second user account. Although a single second user device 106 is shown in FIG. 1, the example system 100 may include any number of user devices associated with the second user. The second user device 106 may be a cellular telephone (including smartphones and/or other types of mobile telephones), laptop, tablet, electronic reader, e-book device, media device, wearable, smart glasses, smartwatch, or any combination of the above. The second user device 106 may be communicably coupled with the user connection server 200, via the network 104, and configured to transmit data to and receive data from the user connection server 200. By way of example, the second user device 106 may include a mobile phone configured to access a second user account associated with the second user.

The deficiency database 110 may be stored by any suitable storage device configured to store some or all of the information described herein (e.g., memory 204 of the user connection server 200 or a separate memory system separate from the user connection server 200, such as one or more database systems, backend data servers, network databases, cloud storage devices, or the like provided by another device (e.g., online application or 3^{rd} party provider) or the first or second user devices 102, 106). The deficiency database 110 may comprise data received from the user connection server 200 (e.g., via a memory 204 and/or processor(s) 202), the first user device 102, and/or the second user device 106, and the corresponding storage device may thus store this data. As defined above, the deficiency database 110 may be configured to store user data, user account data, and/or user account parameters associated with financial deficiencies.

The fulfillment database 112 may also be stored by any suitable storage device configured to store some or all of the information described herein (e.g., memory 204 of the user connection server 200 or a separate memory system separate from the user connection server 200, such as one or more database systems, backend data servers, network databases, cloud storage devices, or the like provided by another device (e.g., online application or 3^{rd} party provider) or the first or second user devices 102, 106). The fulfillment database 112 may comprise data received from the user connection server 200 (e.g., via a memory 204 and/or processor(s) 202), the first user device 102, and/or the second user device 106, and the corresponding storage device may thus store this data. As defined above, the fulfillment database 112 may be configured to store user data, user account data, and/or user account parameters associated with fulfillment opportunities.

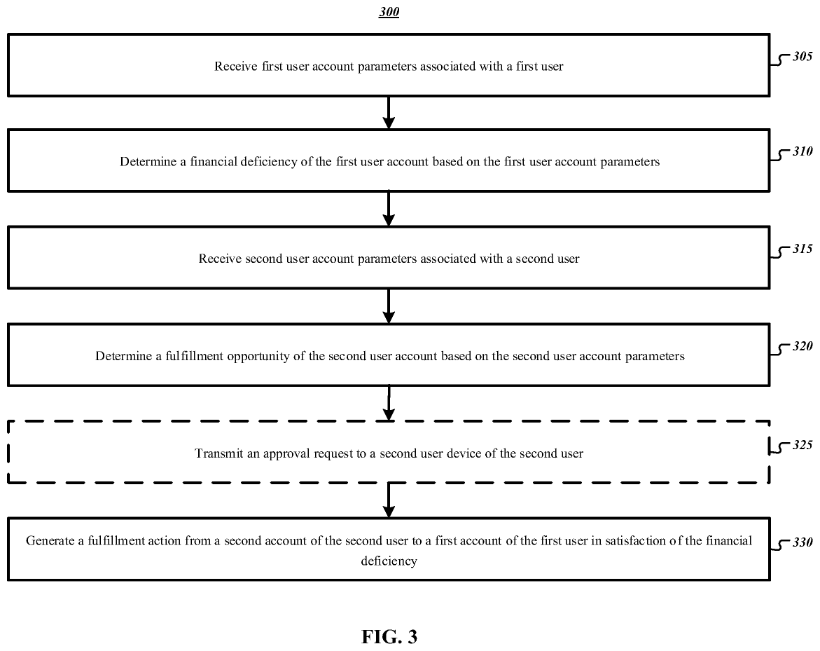

As illustrated in FIG. 2, the user connection server 200 may include a processor 202, a memory 204, communications circuitry 208, and input/output circuitry 206. Moreover, the user connection server 200 may include identification circuitry 210 and/or funding circuitry 212. The user connection server 200 may be configured to execute the operations described below in connection with FIGS. 3-5. Although components 202-212 are described in some cases using functional language, it should be understood that the particular implementations necessarily include the use of particular hardware. It should also be understood that certain of these components 202-212 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the user connection server 200 may be housed within the first user device 102, and/or the second user device 106. It will be understood in this regard that some of the components described in connection with the user connection server 200 may be housed within one of these devices, while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the user connection server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the user connection server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the user connection server 200 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the user connection server, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

The user connection server 200 further includes input/output circuitry 206 that may, in turn, be in communication with processor 202 to provide output to a user and to receive input from a user, user device, or another source. In this regard, the input/output circuitry 206 may comprise a display that may be manipulated by a mobile application. In some embodiments, the input/output circuitry 206 may also include additional functionality such as a keyboard, a mouse, a joystick, a touch screen, touch areas, soft keys, a microphone, a speaker, or other input/output mechanisms. The processor 202 and/or user interface circuitry comprising the processor 202 may be configured to control one or more functions of a display through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the user connection server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the user connection server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The identification circuitry 210 includes hardware components designed to determine financial deficiencies associated with user accounts. The identification circuitry 210 may further include hardware components for determining liquidity thresholds and application denial data entries based upon analysis of user account parameters. The identification circuitry 210 may utilize processing circuitry, such as the processor 202, to perform its corresponding operations, and may utilize memory 204 to store collected information.

The funding circuitry 212 includes hardware components designed to determine fulfillment opportunities. In some embodiments, the funding circuitry 212 may further be configured to generate a fulfillment action between user accounts in satisfaction of a financial deficiency. The funding circuitry 212 may utilize processing circuitry, such as the processor 202, to perform its corresponding operations, and may utilize memory 204 to store collected information.

It should also be appreciated that, in some embodiments, the identification circuitry 210 and/or funding circuitry 212 may include a separate processor, specially configured field programmable gate array (FPGA), or application specific interface circuit (ASIC) to perform its corresponding functions.

In addition, computer program instructions and/or other type of code may be loaded onto a computer, processor, or other programmable user connection server's circuitry to produce a machine, such that the computer, processor other programmable circuitry that execute the code on the machine create the means for implementing the various functions, including those described in connection with the components of user connection server 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Generating User Connections

FIG. 3 illustrates a flowchart containing a series of operations for generating user connections. The operations illustrated in FIG. 3 may, for example, be performed by, with the assistance of, and/or under the control of an apparatus (e.g., user connection server 200), as described above. In this regard, performance of the operations may invoke one or more of processor 202, memory 204, input/output circuitry 206, communications circuitry 208, identification circuitry 210, and/or funding circuitry 212.

As shown in operation 305, the apparatus (e.g., user connection server 200) includes means, such as input/output circuitry 206, communications circuitry 208, or the like, for receiving first user account parameters associated with a first user. As described above, the first user device 102 may be configured to access a first user account that includes first user account parameters. In such an embodiment, the first user device 102 may transmit the first user account parameters to the user connection server 200. In other embodiments, the user connection server 200 may be configured to independently access the first user account in order to receive the first user account parameters. By way of example, the user connection server 200 may host the first user account or be formed integral to a network of a financial institution that hosts the first user account.

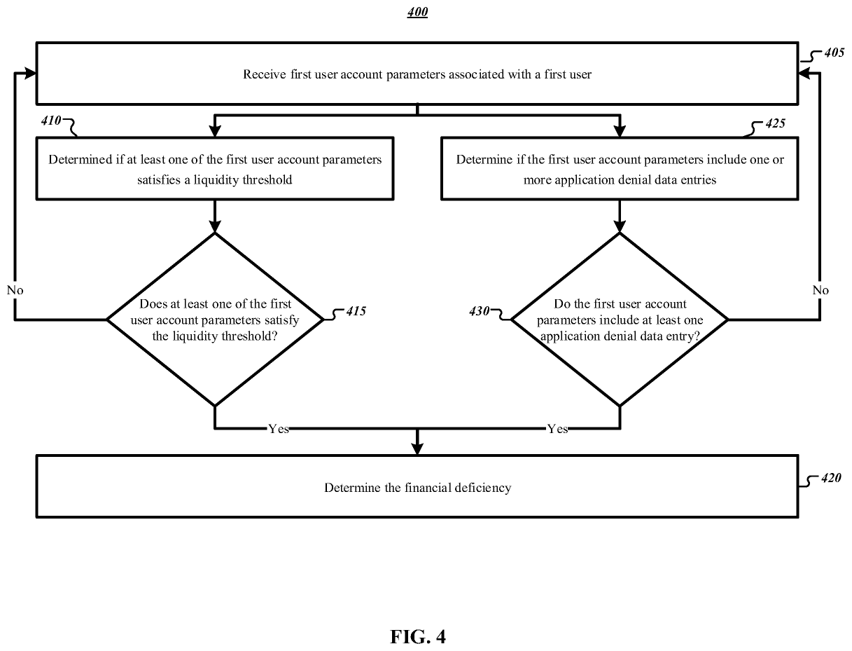

In some embodiments, the first user account parameters received at operation 305 may be transmitted by the first user device 102 in response to a request by the user connection server 200. In other embodiments, the first user account parameters received at operation 305 may be transmitted by the first user device or otherwise made available by the first user (e.g., first user account) in conjunction with an action by the first user or first user account. By way of example, the first user (e.g., first user account) may apply for a small business loan, apply for a line of credit, request loan assistance, request rent workout, file for bankruptcy, and/or any other financial request such that the first user account parameters are received by the user connection server 200 as part of this request. As described hereafter with reference to FIG. 4, in some instances, the first user account parameters may include one or more applicant denial data entries such that the application submission (that is subsequently denied and recorded in the user account parameters) by the first user provides the first user account parameters to the user connection server 200.

Thereafter, as shown in operation 310, the apparatus (e.g., user connection server 200) includes means, such as input/output circuitry 206, communication circuitry 208, identification circuitry 210, or the like, for determining a financial deficiency of the first user account based on the first user account parameters. As described hereafter with reference to FIG. 4, the identification circuitry 210 may be configured to, in response to first user account parameters received at operation 305, determine a financial deficiency of the first user (e.g., first user account). The user connection server 200 may receive first user account parameters at operation 305 from a first user account associated with various information regarding the performance, activity, liquidity, etc. of the first user account. For example, the first user account parameters may include data entries regarding the current balance, pending transactions, accounts receivable, accounts payable, and/or the like associated with the financial performance of the first user account. Furthermore, the user connection server 200 may be configured to analyze these data entries in order to identify trends related to the financial performance of the first user account.

By way of example, the identification circuitry 210 may be configured to analyze the first user account parameters in order to determine the cash flow, revenue per client, client retention rate, gross revenue, profit margin, budget variance, and/or any other performance metric associated with the first user account. In doing so, the identification circuitry 210 may be configured to identify first user account parameters indicative of a liquidity concern of the first user account. By way of a particular example, the identification circuitry 210 may analyze the account balance of the first user account to determine a financial deficiency of the first user account regarding cash flow.

Given that the user connection server 200 may be formed integral to or otherwise as a part of a financial institution, this determination at operation 310 may be configured to determine the validity of a financial deficiency as compared to traditional methods. Said differently, the user connection server's 200 access to the first user account parameters (e.g., complete financials) of the first user account may operate to ensure that the first user's financial performance is indicative of potential future success. In contrast to traditional requests by potential recipients to charitable organizations for funds that rely upon the honesty of the request, the user connection server 200 of the described herein may confirm the validity of the financial deficiency. Furthermore, such a determination at operation 310 may not require an active request for funds by the potential recipient (e.g., first user). Even in instances in which the first user account applies for loan funds or the like as described hereafter, the first user account may be unaware of the user connection server's 200 separate determination regarding financial deficiencies.

With continued reference to operation 310, and as described hereafter with reference to FIG. 4, the identification circuitry 210 may be configured to, in response to first user account parameters received at operation 305, determine one or more application denial data entries of the first user (e.g., first user account). The user connection server 200 may receive first user account parameters at operation 305 from a first user account associated with various information regarding applications filed by the first user for financial assistance (e.g., loan requests or the like). For example, the first user account parameters may include data entries regarding application or other requests for funding made by the first user that were unsuccessful (e.g., denied). As above, the user connection server 200 may be formed integral to or otherwise as a part of a financial institution such that this determination at operation 310 may be configured to determine the validity of a financial deficiency as compared to traditional methods. Said differently, the user connection server 200 may operate to determine if the first user (e.g., first user account) has previously sought help or other financial assistance.

Thereafter, as shown in operation 315, the apparatus (e.g., user connection server 200) includes means, such as processor 202, communication circuitry 208, or the like, for receiving second user account parameters associated with a second user. As described above, the second user device 106 may be configured to access a second user account that includes second user account parameters. In such an embodiment, the second user device 106 may transmit the second user account parameters to the user connection server 200. In other embodiments, the user connection server 200 may be configured to independently access the second user account in order to receive the second user account parameters. By way of example, the user connection server 200 may host the second user account or be formed integral to a network of a financial institution that hosts the second user account.

In some embodiments, the second user account parameters received at operation 315 may be transmitted by the second user device 106 or otherwise made available by the second user (e.g., second user account) in conjunction with an action by the second user or second user account. By way of example, the second user (e.g., second user account) may transmit a request to the user connection server 200 for assistance with charitable giving, financial donations, and/or the like such that the second user account parameters are received by the user connection server 200 as part of this request. Said differently, the second user (e.g., second user account) may actively request to assist in the fulfillment actions described hereafter.

In some embodiments, as shown in operation 320, the apparatus (e.g., user connection server 200) includes means, such as processor 202, funding circuitry 212, or the like, for determining a fulfillment opportunity of the second user account based on the second user account parameters. As described above, the user connection server 200 may, in some embodiments, receive a request from the second user (e.g., second user device 106) indicating the willingness of the second user to fund or otherwise provide financial assistance to others. In such an embodiment, the funding circuitry 212 at operation 320 may determine a fulfillment opportunity of the second user account in response to the second user's request to provide financial assistance (e.g., based on the second user account parameters regarding the same). Given that the user connection server 200 may be formed integral to or otherwise as a part of a financial institution, this determination at operation 310 may be configured to provide security and/or anonymity to the second user. Said differently, the user connection server's 200 may operate to shield the second user from publicity, if any, regarding the transfer of funds (e.g., donation) described herein. Furthermore, due to association with the second user's financial institution and, in some embodiments hosting the second user's account, the second user may be confident that the funds described hereafter are provided to a worthy cause (e.g., the first user).

In some embodiments, the user connection server 200 may receive second user account parameters at operation 315 from a second user account associated with various information regarding the financial information of the second user. For example, the second user account parameters may include data entries regarding the current balance, pending transactions, accounts receivable, accounts payable, and/or the like associated with the financial performance of the second user account. Furthermore, the user connection server 200 may be configured to analyze these data entries in order to identify trends related to the financial performance of the second user account.

By way of example, the funding circuitry 210 may be configured to analyze the second user account parameters in order to determine the cash flow, revenue per client, client retention rate, gross revenue, profit margin, budget variance, and/or any other performance metric associated with the second user account. In doing so, the funding circuitry 212 may be configured to identify second user account parameters indicative of an ability and willingness to fund a fulfillment action (e.g., donate). By way of further example, the funding circuitry 212 may analyze the account balance of the second user account to determine a positive cash flow of the second user account and one or more prior charitable donations (e.g., via analysis of the transactions of the second user account). Although described herein with reference to cash flow and charitable donations, the present disclosure contemplates that any number of business metrics, activities of the second user, and/or the like may be analyzed by the funding circuitry 212 in order to determine a fulfilment opportunity at operation 320.

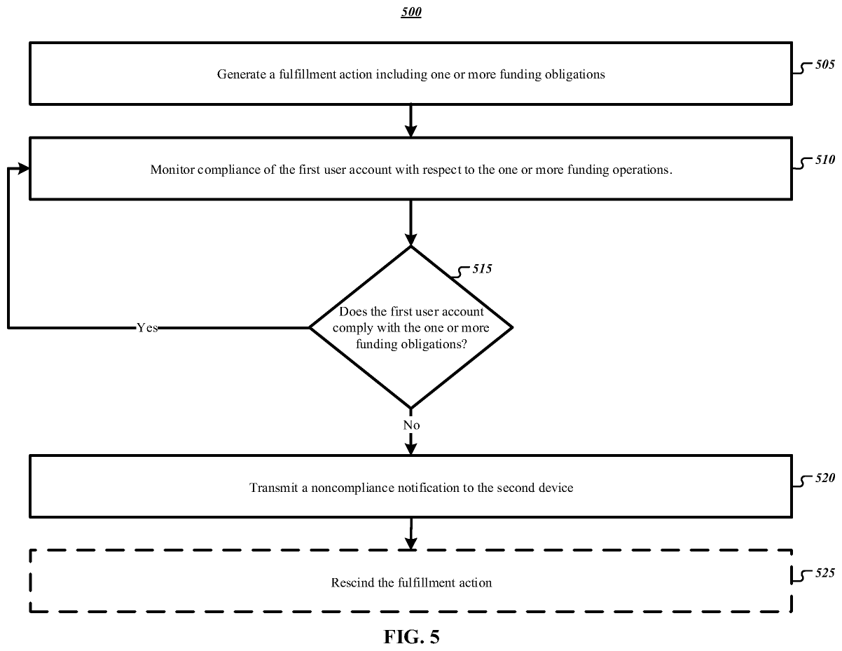

In some embodiments, as shown in operation 325, the apparatus (e.g., user connection server 200) includes means, such as processor 202, communications circuitry 208, or the like, for transmitting an approval request to the second user device 106 of the second user. In an instance in which the identification circuitry determines a financial deficiency of the first user account and the funding circuitry 212 determines a fulfillment opportunity of the second user account, the communications circuitry 208 may transmit a notification (e.g., approval request) to the second user device 106 for review and/or approval. The approval request, in some embodiments, may include a portion of the first user account parameters (e.g., anonymized relevant financial information) as well as information regarding the fulfillment action (e.g., amount of donation, terms of donation agreement, and/or the like) described hereafter. The approval request may provide one or more options for selection by the second user (e.g., approve, disapprove, other, etc.) to allow the second user the respond accordingly. In some embodiments, the approval request may allow the second user to determine various funding obligations (e.g., installment payments, spending limitations, etc.) as described hereafter with reference to FIG. 5.

In some embodiments, determination of a fulfillment opportunity of the second user account may further include authenticating the second user device associated with the second user account (e.g., establishing an authenticated session). As such, transmission of an approval request to the second user device of the second user at operation 325 may include generation of an authenticated session between the second user device 106 and the user connection server 200. By way of example, the input/output circuitry 206, communications circuitry 208, or the like may transmit, as part of an approval request, for example, a request for an input of a user identifier (e.g., username, password, personal identification number (PIN), etc.) by the second user. Such a request may also request, for example, a biometric input (e.g., fingerprint scan, optical scan, facial scan, etc.) of the second user in order to authenticate a session between the second user device 106 and the user connection server 200. Given that the fulfillment action from the second account of the second user to the first account of the first user in satisfaction of the financial deficiency may include multiple transactions (e.g., installment payments) as described herein, the present disclosure contemplates that an authenticated session may be generated for each interaction between the second user device 106 and the user connection server 200. Furthermore, although described herein with reference to an authenticated session between the second user device 106 and the user connection server 200, the present disclosure contemplates that one or more authenticated sessions may be generated for interactions between the first user device 102 and the user connection server 200.

Thereafter, as shown in operation 330, the apparatus (e.g., user connection server 200) includes means, such as input/output circuitry 206, funding circuitry 212, identification circuitry 210, or the like, for generating a fulfillment action from a second account of the second user to a first account of the first user in satisfaction of the financial deficiency. The fulfillment action generated at operation 330 may, in some embodiments, be provided as a wire transfer, real-time payment (RTP), an automated clearing house (ACH) transaction, or other payment mechanism that may be directed to the first user account. In some embodiments, the fulfillment action may include identifying information of the second user. In other embodiments, the fulfillment action may be anonymous (e.g., without identifying information of the second user). In some other embodiments, the fulfillment action may be provided to a centralized account, escrow, or the like configured to collect fulfillment actions. In such an embodiment, the centralized account, escrow, or the like may operate to disburse the funds of the fulfillment action to the first user account. For example, the fulfillment action may be provided to the first user account in installments such that the fulfilment action is initially provided to the centralized account from the second user account and subsequently disbursed to the first user account at regular intervals or in response to completed action by the first user.

Turning next to FIG. 4, a flowchart is shown for financial deficiency determinations. The operations illustrated in FIG. 4 may, for example, be performed by, with the assistance of, and/or under the control of an apparatus (e.g., user connection server 200), as described above. In this regard, performance of the operations may invoke one or more of processor 202, memory 204, input/output circuitry 206, communications circuitry 208, identification circuitry 210, and/or funding circuitry 212.

As shown in operation 405, the apparatus (e.g., user connection server 200) includes means, such as input/output circuitry 206, communications circuitry 208, or the like, for receiving first user account parameters associated with a first user. As described above with reference to operation 305, the first user device 102 may be configured to access a first user account that includes first user account parameters. In such an embodiment, the first user device 102 may transmit the first user account parameters to the user connection server 200. In other embodiments, the user connection server 200 may be configured to independently access the first user account in order to receive the first user account parameters. In some other embodiments, the first user account parameters received at operation 305 may be transmitted by the first user device 102 in response to a request by the user connection server 200. In other embodiments, the first user account parameters received at operation 305 may be transmitted by the first user device or otherwise made available by the first user (e.g., first user account) in conjunction with an action by the first user or first user account.

As shown in operations 410 and 415, the apparatus (e.g., user connection server 200) includes means, such as input/output circuitry 206, communications circuitry 208, identification circuitry 210, or the like, for determining if at least one of the first user account parameters satisfies a liquidity threshold. As described above, the identification circuitry 210 may receive first user account parameters at operation 305 from a first user account associated with various information regarding the performance, activity, liquidity, etc. of the first user account. For example, the first user account parameters may include data entries regarding the current balance, pending transactions, accounts receivable, accounts payable, and/or the like associated with the financial performance of the first user account. Furthermore, the user connection server 200 may be configured to analyze these data entries in order to identify trends related to the financial performance of the first user account.

By way of example, the identification circuitry 210 may be configured to analyze the first user account parameters in order to determine the cash flow, revenue per client, client retention rate, gross revenue, profit margin, budget variance, and/or any other performance metric associated with the first user account. In doing so, the identification circuitry 210 may be configured to identify first user account parameters indicative of a liquidity concern of the first user account. By way of further example, the identification circuitry 210 may analyze the account balance of the first user account to determine a financial deficiency of the first user account regarding cash flow.

With continued reference to operations 410 and 415, the first user account parameters may be compared with one or more liquidity thresholds to determine if at least one of the first user account parameters satisfies the liquidity threshold. By way of example, the first user account parameters may be associated with current balance and pending transactions. The liquidity threshold may be defined as $1,000 such that any first user account parameters that indicate a remaining balance that exceeds $1,000 fails to satisfy the threshold for this parameter. Said differently, the cashflow and pending transactions of the first user account are such that a financial deficiency is not present. In an instance in which the first user account parameters indicate that the first user account fails to exceed a remaining balance of $1,000, the user connection server 200 may determine that at least one first user account parameter satisfies the liquidity threshold at operations 410 and 415. In such an instance, the apparatus (e.g., user connection server 200) may include means, such as input/output circuitry 206, identification circuitry 210, or the like, for determining a financial deficiency at operation 420. Although described herein with reference to cash flow, pending transactions, and remaining balance, the present disclosure contemplates that the user connection server 200 may analyze any business metric (e.g., cash flow, revenue per client, client retention rate, gross revenue, profit margin, budget variance, and/or any other performance metric associated with the first user account) and an associated threshold, alone or in combination, based upon the intended application of the server 200.

As shown in operations 425 and 430, the apparatus (e.g., user connection server 200) includes means, such as input/output circuitry 206, communications circuitry 208, identification circuitry 210, or the like, for determining if the first user account parameters include one or more application denial data entries. As described above, the identification circuitry 210 may receive first user account parameters at operation 405 from a first user account associated with various information regarding applications filed by the first user for financial assistance (e.g., loan requests or the like). For example, the first user account parameters may include data entries regarding application or other requests for funding made by the first user that were unsuccessful (e.g., denied). In an instance in which the identification circuitry 210 identifies at least one application denial data entry (e.g., at least one prior request and subsequent denial), the user connection server 200 may include means, such as input/output circuitry 206, identification circuitry 210, or the like, for determining a financial deficiency at operation 420. In an instance in which the identification circuitry 210 fails to identify at least one application denial data entry (e.g., at least one prior request and subsequent denial), the user connection server 200 may return to analyzing first user account parameters of the first user.

Turning next to FIG. 5, a flowchart is shown for funding obligation monitoring. The operations illustrated in FIG. 5 may, for example, be performed by, with the assistance of, and/or under the control of an apparatus (e.g., user connection server 200), as described above. In this regard, performance of the operations may invoke one or more of processor 202, memory 204, input/output circuitry 206, communications circuitry 208, and/or funding circuitry 212.

As shown in operation 505, the apparatus (e.g., user connection server 200) includes means, such as input/output circuitry 206, communications circuitry 208, funding circuitry 212, or the like, for generating a fulfillment action including one or more funding obligations. As described above, the fulfillment action generated at operation 505 may, in some embodiments, be provided as a wire transfer, real-time payment (RTP), an automated clearing house (ACH) transaction, or other payment mechanism that may be directed to the first user account. In some embodiments, the fulfillment action may include identifying information of the second user. In other embodiments, the fulfillment action may be anonymous (e.g., without identifying information of the second user). In some other embodiments, the fulfillment action may be provided to a centralized account, escrow, or the like configured to collect fulfillment actions.

The fulfillment action may further include one or more funding obligations that may operate to control spending of the funds provided by the fulfillment action. In particular, in some embodiments, the user connection server 200 may place limitations regarding how the funds provided to the first user account via the fulfillment action may be spent. The funding obligations may be determined, in some embodiments, by the user connection server 200. In other embodiments, the funding obligations may be determined by the second user via information provided in response the approval request described at operation 325 or otherwise. In this way, the second user (e.g., donor or benefactor) may ensure that the funds they provide are used as intended.

By way of example, the one or more funding obligations may limit the first user account to using the funds of the fulfillment action to operations related to the business of the first user account (e.g., payroll, rent, outstanding business debts, and/or the like). In some embodiments, the one or more funding obligations may provide timing related limitations regarding the funds provided by the fulfillment action. By way of example, the one or more funding obligations may dictate that the first user account maintain the funds in the first user account for a determined period of time (e.g., rainy day fund) before spending. In some embodiments, the one or more funding obligations may provide action related limitations regarding the funds provided by the fulfillment action. By way of example, the one or more funding obligations may require completion of one or more actions (e.g., maintain a set number of employees on payroll, meet financial obligations regarding payment of suppliers, etc.) by the first user account (e.g., the first user) before providing initial and/or additional funds.

Thereafter, as shown in operations 510 and 515, the apparatus (e.g., user connection server 200) includes means, such as processor 202, communications circuitry 208, identification circuitry 210, or the like, for monitoring compliance of the first user account with respect to the one or more funding operations and determining if the first user account complies with the one or more funding obligations. Given that the user connection server 200 may be formed integral to or otherwise as a part of a financial institution, the user connection server 200 may be uniquely positioned to monitor the financial actions of the first user account and determine if the first user fails to comply with the terms of the funding obligations. In contrast to traditional recipients of charitable funds whose actions following receipt of the funds are no longer accounted for, the user connection server 200 of the described herein may ensure that the funds provided by the second user account (e.g., second user) are used in accordance with the intent of the second user.

In an instance in which the first user account fails to comply with the one or more funding obligations, the apparatus (e.g., user connection server 200) includes means, such as input/output circuitry 206, communications circuitry 208, funding circuitry 212, or the like, for, as shown in operation 520, transmitting a noncompliance notification to the second user device 106. In some embodiments, the funding obligations may be determined by the second user. As such, in instances in which the first user account fails to operate within the terms set by the funding obligations, the user connection server 200 may notify the second user of noncompliance.

In some embodiments, as shown in operation 525, the apparatus (e.g., user connection server 200) includes means, such as input/output circuitry 206, communications circuitry 208, funding circuitry 212, or the like, for rescinding the fulfillment action. In particular, the user connection server 200 may actively monitor operation of the first user account to identify instances in which the first user account fails to comply with one or more funding obligations of the fulfillment action. In an instance in which the user connection server 200 determines noncompliance by the first user account, the server 200 may rescind the funds of the fulfillment action by removing access of the first user account to the funds and/or returning the funds to the second user account. By way of example, the user connection server 200 may determine that the first user account fails to comply with a usage related funding obligation regarding payroll and instead attempts to use the funds of the fulfillment action for personal use. The user connection server may rescind the fulfillment action and notify the first user account of the same. Due the association between the user connection server 200 and the financial institutions hosting the first user account, the user connection server 200 may appropriately monitor and, if necessary, efficiently return funds to the second user account.

In doing so, the embodiments of the present disclosure solve issues regarding connecting users for financial transactions (e.g., charitable donations) by utilizing financial deficiency determinations and associated fulfillment actions. The embodiments of the present application may further receive account parameters of a second user (e.g., HNW individual) and determine a fulfillment opportunity based on the account parameters of this second user. In response to the fulfillment opportunity, the described systems may generate a fulfillment action from an account of the second user to an account of the first user in satisfaction of the financial deficiency. In this way, the inventors have identified that the advent of emerging computing technologies have created a new opportunity for solutions for generating user connections which were historically unavailable. In doing so, such example implementations confront and solve at least three technical challenges: (1) they automatically determine financial deficiencies associated with users, (2) they dynamically identify user fulfillment opportunities, and (3) they streamline financial transactions between selected users.

FIGS. 3-5 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the user connection server 200 and executed by a processor 202 of the user connection server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### Conclusion

Many modifications of the embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for generating user connections, the method comprising:
receiving, via a computing device, first user account parameters associated with a first user;
determining, via identification circuitry of the computing device, that the first user account parameters comprise an application denial data entry indicative of a previous denial of a request for funding by the first user;
determining, via the identification circuitry of the computing device, a financial deficiency of the first user based on the first user account parameters comprising the application denial data entry;
identifying, via the identification circuitry, the first user as a recipient of a fulfillment opportunity based on the financial deficiency;
receiving, via the computing device, second user account parameters associated with a second user;
determining, via funding circuitry of the computing device, the fulfillment opportunity of the second user based on the second user account parameters;
in response to the fulfillment opportunity, generating, via the funding circuitry of the computing device, a fulfillment action from a second account of the second user to a first account of the first user in satisfaction of the financial deficiency, wherein the fulfillment action comprises one or more funding obligations;
monitoring, via the funding circuitry, compliance of the first user account with respect to the one or more funding obligations, wherein the one or more funding obligations comprise one or more action related limitations of the first user account; and
rescinding, via the funding circuitry, the fulfillment action in an instance in which the first user account fails to comply with the one or more funding obligations.

2. The method according to claim 1, wherein determining the fulfillment opportunity further comprises transmitting, via the computing device, an approval request to a second user device of the second user.

3. The method according to claim 2, further comprising, generating, via the funding circuitry, the fulfillment action in an instance in which the computing device receives an approval notification from the second user device.

4. The method according to claim 1, wherein determining the financial deficiency further comprises:
determining, via the identification circuitry, that at least one of the first user account parameters satisfies a liquidity threshold; and
determining, via the identification circuitry, the financial deficiency in an instance in which at least one of the first user account parameters satisfies the liquidity threshold.

5. (canceled)

6. (canceled)

7. (canceled)

8. The method according to claim 1, further comprising transmitting, via the computing device, a noncompliance notification to a second user device in an instance in which the first user account fails to comply with the one or more funding obligations.

9. (canceled)

10. An apparatus for generating user connections, the apparatus comprising:
communications circuitry configured to:
receive first user account parameters associated with a first user; and
receive second user account parameters associated with a second user;
identification circuitry configured to:
determine that the first user account parameters include an application denial data entry indicative of a previous denial of a request for funding by the first user;
determine a financial deficiency of the first user based on the first user account parameters comprising the application denial data entry;
funding circuitry configured to:
identify the first user as a recipient of a fulfillment opportunity based on the financial deficiency; and
determine a fulfillment opportunity of the second user account based on the second user parameters;
in response to the fulfillment opportunity, generate a fulfillment action from a second account of the second user to a first account of the first user in satisfaction of the financial deficiency, wherein the fulfillment action comprises one or more funding obligations;
monitor compliance of the first user account with respect to the one or more funding obligations, wherein the one or more funding obligations comprise one or more action related limitations on the first user account and
rescind the fulfillment action in an instance in which the first user account fails to comply with the one or more funding obligations.

11. The apparatus according to claim 10, wherein the communications circuitry is further configured to, in response to determining the fulfillment opportunity, transmit an approval request to a second user device of the second user.

12. The apparatus according to claim 11, wherein the funding circuitry is further configured to generate the fulfillment action in an instance in which the computing device receives an approval notification from the second user device.

13. The apparatus according to claim 10, wherein the identification circuitry is further configured to:
determine that at least one of the first user account parameters satisfies a liquidity threshold; and
determine the financial deficiency in an instance in which at least one of the first user account parameters satisfies the liquidity threshold.

14. (canceled)

15. (canceled)

16. (canceled)

17. The apparatus according to claim 10, wherein the communications circuitry is further configured to transmit a noncompliance notification to a second user device in an instance in which the first user account fails to comply with the one or more funding obligations.

18. (canceled)

19. A non-transitory computer-readable storage medium for generating user connections, the non-transitory computer-readable storage medium storing instructions that, when executed:
receive first user account parameters associated with a first user;
determine that the first user account parameters include an application denial data entry indicative of a previous denial of a request for funding by the first user;
determine a financial deficiency of the first user based on the first user account parameters comprising the application denial data entry;
receive second user account parameters associated with a second user;
determine the fulfillment opportunity of the second user based on the second user account parameters;
in response to the fulfillment opportunity, generate a fulfillment action from a second account of the second user to a first account of the first user in satisfaction of the financial deficiency, wherein the fulfillment action comprises one or more funding obligations;
monitor compliance of the first user account with respect to the one or more funding obligations, wherein the one or more funding obligations comprise one or more action related limitations on the first user account and
rescind the fulfillment action in an instance in which the first user account fails to comply with the one or more funding obligations.

20. The non-transitory computer-readable storage medium according to claim 19 storing instructions that, when executed, transmit an approval request to a second user device of the second user.

21. The non-transitory computer-readable storage medium according to claim 20, storing instructions that, when executed, generate the fulfillment action in an instance in which the computing device receives an approval notification from the second user device.

22. The non-transitory computer-readable storage medium according to claim 19, storing instructions that, when executed:
determine that at least one of the first user account parameters satisfies a liquidity threshold; and
determine the financial deficiency in an instance in which at least one of the first user account parameters satisfies the liquidity threshold.

23. The non-transitory computer-readable storage medium according to claim 19, wherein the funding obligation further comprises a timing related limitation defining a requirement that the first user account maintain the fulfillment action in the first user account for a determined period of time.

24. The non-transitory computer-readable storage medium according to claim 19, storing instructions that, when executed, remove at least a portion of funds associated with the fulfillment action from the first user account.

25. The method according to claim 1, wherein the funding obligation further comprises a timing related limitation defining a requirement that the first user account maintain the fulfillment action in the first user account for a determined period of time.

26. The method according to claim 1, wherein the rescinding of the fulfillment action comprises removing at least a portion of funds associated with the fulfillment action from the first user account.

27. The apparatus according to claim 10, wherein the funding obligation comprises a timing related limitation defining a requirement that the first user account maintain the fulfillment action in the first user account for a determined period of time.

28. The apparatus according to claim 10, wherein the funding circuitry is further configured to, in rescinding the fulfillment action, remove at least a portion of funds associated with the fulfillment action from the first user account.
